(19) United States
(12) Patent Application Publication
(10) Pub. No.: US 2015/0163279 A1
(43) Pub. Date: Jun. 11, 2015

(54) APPARATUS AND METHOD FOR TRANSFERRING CONTENT BETWEEN SERVICES

(71) Applicant: Nokia Corporation, Espoo (FI)

(72) Inventor: Noam Rosenthal, Berlin (DE)

(73) Assignee: Nokia Corporation, Espoo (FI)

(21) Appl. No.: 14/099,373

(22) Filed: Dec. 6, 2013

(51) Int. Cl. H04L 29/08

(52) U.S. Cl. CPC H04L 67/02

(57) ABSTRACT

An apparatus, method, and computer program product are described for allowing a user to transfer content between web services, so as to allow the communication of content directly from one service to another, without needing to rely on a backend connection or the manual downloading and uploading of the content to and from a local device performed by the user. Rather, the user may be able to initiate the transfer of content between services through interaction with a user agent, such as a web browser used by the user to access web content. Thus, at the request of the user, content that was previously accessible through one website may be shared with another website through a “side-loading” type of operation.

### TECHNOLOGICAL FIELD

Example embodiments of the present invention relate generally to facilitating the transfer of content between services, such as web services.

### BACKGROUND

In the modern age of computing, websites abound for providing users with content and the ability to manipulate and share that content with other users. From social networking websites to informational websites, retail websites to gaming websites, practically anything that a user wishes to learn about or accomplish can be found on a website. At the same time, the level of technical computer science skill possessed by most users is minimal. In most cases, a user only needs to have a user device that can access the Internet, such as a mobile phone, laptop computer, tablet computer, etc., and a very basic knowledge of how to operate the device in order to view and interact with website content.

### BRIEF SUMMARY OF EXAMPLE EMBODIMENTS

With so much content available and so many websites to choose from, it is often desirable for a user to share content between websites. For example, a user may want to use the photo she previously uploaded to a social networking account in an album she is creating on a photo sharing website. Accordingly, it may be desirable to provide tools that allow users to easily and intuitively share content between web services.

In some embodiments, an apparatus may be provided that includes at least one processor and at least one memory including computer program code. The at least one memory and the computer program code may be configured to, with the processor, cause the apparatus to provide for display of a webpage to a user, wherein the webpage is associated with a first service. The memory and computer program code may be further configured to, with the processor, cause the apparatus to receive input from the user, via the webpage, designating content to be transferred to the webpage, wherein the content is accessible via a second service, and to provide for transfer of the content designated from the second service to the first service and at the direction of the first service in response to the receipt of the input.

In some cases, the at least one memory and the computer program code may be further configured to, with the processor, cause the apparatus to detect a user interface element in the webpage displayed to the user, wherein the user interface element is configured to receive the input from the user regarding the transfer of content to the first service. The at least one memory and the computer program code may be configured to, with the processor, cause the apparatus to provide for display of an option to the user to transfer content from the second service to the first service in response to detection of the user interface element, wherein the input from the user designating the content to be transferred is received via the option presented to the user.

The at least one memory and the computer program code may be configured to, with the processor, cause the apparatus to receive input designating the content via a user interface component of a user agent used by the user to access the webpage. Additionally or alternatively, the at least one memory and the computer program code may be configured to, with the processor, cause the apparatus to receive input designating the content via a file dialog component of an operating system used by the user to access the webpage.

The at least one memory and the computer program code may be further configured to, with the processor, cause the apparatus to determine an acceptable type of content for transfer to the first service. The at least one memory and the computer program code may be configured to, with the processor, cause the apparatus to identify at least one second service capable of providing content according to the type of content determined to be acceptable.

In other embodiments, a method and a computer program product are described that provide for display of a webpage to a user, wherein the webpage is associated with a first service; receive input from the user, via the webpage, designating content to be transferred to the webpage, wherein the content is accessible via a second service; and provide for transfer of the content designated from the second service to the first service and at the direction of the first service in response to the receipt of the input.

In some cases, a user interface element may be detected in the webpage displayed to the user, wherein the user interface element is configured to receive the input from the user regarding the transfer of content to the first service. Receiving input from the user via the webpage may comprise receiving input designating the content via a user interface component of a user agent used by the user to access the webpage. Additionally or alternatively, receiving input from the user via the webpage may comprise receiving input designating the content via a file dialog component of an operating system used by the user to access the webpage.

In some cases, an acceptable type of content for transfer to the first service may be determined. Moreover, at least one second service capable of providing content according to the type of content determined to be acceptable may be identified.

In still other embodiments, an apparatus is provided for sharing content between web services. The apparatus may include means for providing for display of a webpage to a user, wherein the webpage is associated with a first service; means for receiving input from the user, via the webpage, designating content to be transferred to the webpage, wherein the content is accessible via a second service; and means for providing for transfer of the content designated from the second service to the first service and at the direction of the first service in response to the receipt of the input.

### BRIEF DESCRIPTION OF THE SEVERAL VIEWS OF THE DRAWING(S)

Having thus described example embodiments of the invention in general terms, reference will now be made to the accompanying drawings, which are not necessarily drawn to scale, and wherein:

FIG. 1 illustrates one example of a network environment according to an example embodiment of the present invention;

FIG. 2 illustrates one example of a communication system according to an example embodiment of the present invention;

FIG. 3 illustrates a schematic block diagram of an apparatus for providing for the transfer of content between services according to an example embodiment of the present invention;

FIG. 4 illustrates a schematic block diagram of a system for transferring content from one service to another in a backend scenario;

FIG. 5 illustrates a schematic block diagram of a system for transferring content from one service to another in a downloading/uploading scenario;

FIG. 6 illustrates a schematic block diagram of a system for providing for the transfer of content between services according to an example embodiment of the present invention;

FIG. 7 illustrates a webpage associated with a first service according to an example embodiment of the present invention;

FIG. 8 illustrates the webpage of FIG. 7 including a user interface for receiving user input designating content to be transferred according to an example embodiment of the present invention;

FIG. 9 illustrates the webpage of FIG. 7 including a file dialog component for receiving user input designating content to be transferred according to an example embodiment of the present invention; and

FIG. 10 illustrates a flowchart of methods of providing for the transfer of content between services according to an example embodiment of the present invention.

### DETAILED DESCRIPTION

Some example embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As noted above, users often look to multiple websites to meet their various content consumption needs. From social networking sites like Facebook to professional networking sites like LinkedIn; photo sharing sites like SmugMug to media sharing sites like YouTube; retail sites like Amazon to classified advertising sites like Craig's List—users often navigate between sites to find content they need or want and to communicate content with other users.

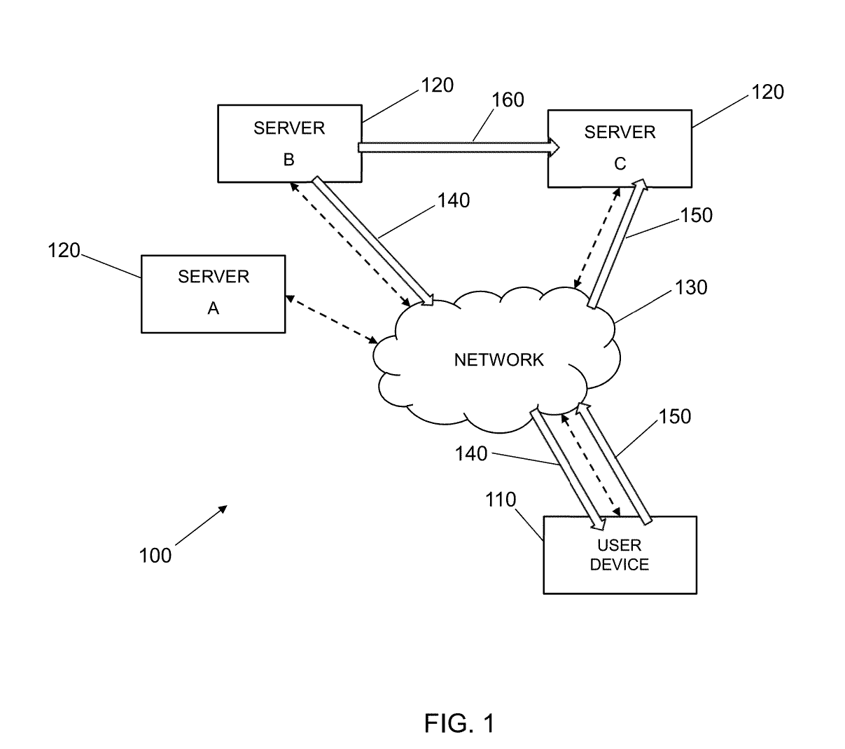

An example networking environment 100 is illustrated in FIG. 1 which includes a user device 110 communicating with one or more servers 120 over a network 130, such as the Internet. The servers 120 may, for example, help to deliver web content that can be accessed via the network 130, such as web servers that host websites (e.g., web services). The user device 110 may be any of a number of devices that a user can interact with to access the content provided by the servers 120 over the network 130, such as portable digital assistants (PDAs), smart phones, laptop computers, tablet computers, touch surfaces, and so on.

When a user identifies desirable content residing in a remote network location, such as on a web server 120 hosting a particular website the user is viewing, the user may wish to download the content. By downloading the content, the user may receive a copy of the desired file from the remote network location, and the file may be saved locally to the user's personal device 110, such as the user's personal computer or smart phone. The downloading of content from Server B is represented in FIG. 1 by an arrow 140. Similarly, a user may wish to provide locally-saved content (e.g., content saved on the user device 110) to a web server 120, for example, to allow such content to be shared with others via the website hosted by the web server. In such a case, represented in FIG. 1 by an arrow 150, the user may upload content from the user device 110 a particular server 120, such as by sending a copy of the file to Server C via the network 130 as illustrated.

Often times, a user may wish to transfer content between two web services. For example, a user may post a photo to the user's social networking account to share with the user's friends. A few days later, the user may wish to compile an album of photos on the user's photo sharing account and may want to include the photo she posted on her social networking account in that album.

According to some conventional systems and devices, the user may be able to rely on a backend connection between the two websites, such as in a situation in which one of the servers 120 hosting the source website (in this case, the social networking website) is configured (e.g., pre-programmed) to communicate and share files with another server hosting the destination website (in this case, the photo website). A backend solution, however, requires that the two websites are preprogrammed (e.g., include program code instructions on a server side of one or both websites) to communicate with one another to transfer content. Although such communication, represented by the arrow 160, may be preprogrammed in the case of some websites for which inter-website communication is desired and expected (e.g., as between a social networking server and an email server), in situations in which this type of communication is not expected, but is nonetheless desired by the user, a backend solution may not be available, and the user may need to perform a manual download-upload operation (e.g., as depicted by arrows 140, 150).

Thus, if a backend solution is not available in this example, and if the user does not have a copy of the desired photo saved locally (e.g., on the user's local device 110 in FIG. 1) so as to allow the user to upload a copy of the photo to the photo sharing site, the user in this scenario would have to download the photo from the social networking site (e.g., from Server B) to the user device 110 (e.g., along the download arrow 140), then upload the photo from the user device to the photo sharing site (e.g., to Server C, along the upload arrow 150). Such a solution, however, requires the user to deal with technical computing instructions associated with downloading and uploading content and involves extra steps that can be inefficient, time consuming, and potentially lead to errors on the part of the user in performing these steps.

Accordingly, embodiments of the present invention provide an apparatus, method, and computer program product for allowing a user to transfer content between web services, so as to allow the communication of content directly from one website to another, without needing to rely on a backend connection or a manual download-upload operation performed by the user. Rather, embodiments of the invention are implemented in the user agent (e.g., the web browser used by the user to access the web content) and, at the request of the user, provide for content on one website to be shared with another through a “side-loading” type of operation.

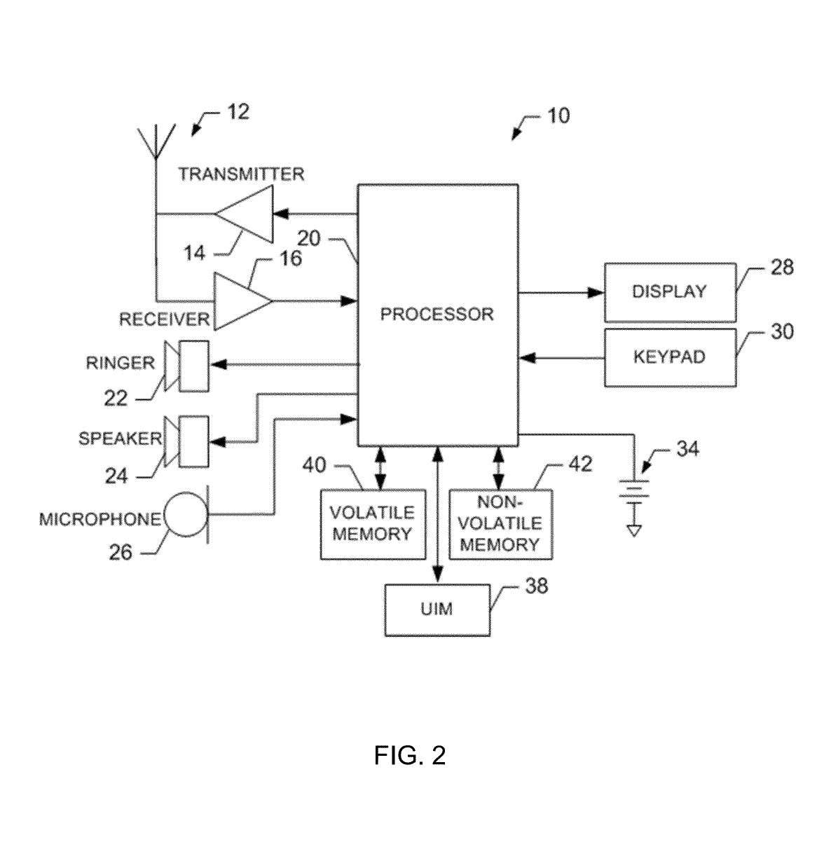

Turning now to FIG. 2, which provides one example embodiment, a block diagram of a mobile terminal 10 that would benefit from embodiments of the present invention is illustrated. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

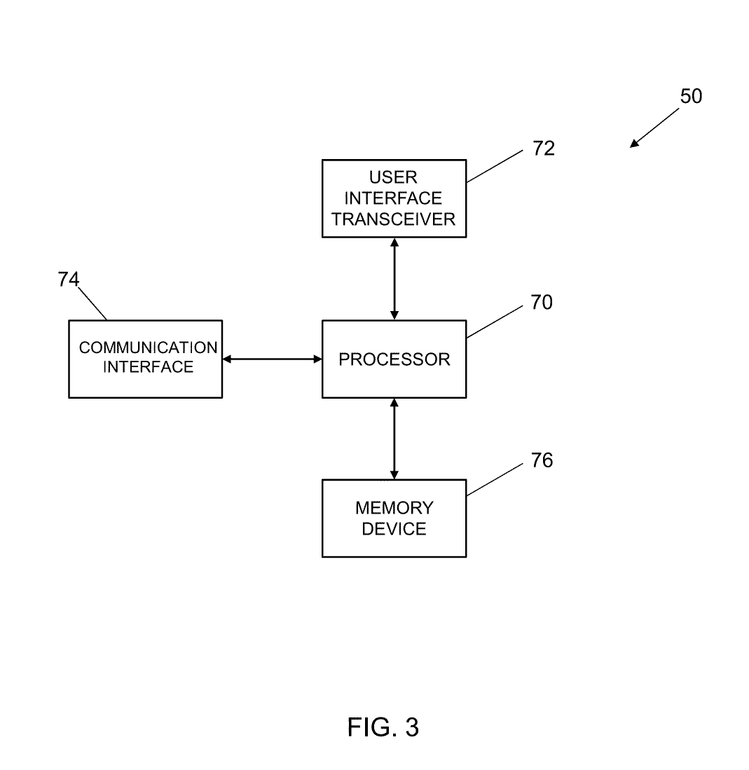

Referring again to FIG. 2, the mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 3), which controls the provision of signals to and the receipt of signals from the transmitter 14 and receiver 16, respectively. The signals may include signaling information in accordance with the air interface standard of the applicable cellular system, and also user speech, received data and/or user generated data. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the invention will now be described with reference to FIG. 3, which depicts certain elements of an apparatus 50 for providing for the transfer of content between services. As used herein, the term “service” refers to a remote provider of content that is accessible to a user device, such as a web service that operates through a website, as described in greater detail below. The apparatus 50 of FIG. 3 may be employed, for example, with the mobile terminal 10 of FIG. 2. However, it should be noted that the apparatus 50 of FIG. 3 may also be employed in connection with a variety of other devices, both mobile and fixed, such as a server as described below, and therefore, embodiments of the present invention should not be limited to application on devices such as the mobile terminal 10 of FIG. 2. For example, the apparatus 50 may be employed on a personal computer, a tablet, a mobile telephone, or other user terminal. Moreover, in some cases, part or all of the apparatus 50 may be on a fixed device such as a server or other service platform and the content may be presented (e.g., via a server/client relationship) on a remote device such as a user terminal (e.g., the mobile terminal 10) based on processing that occurs at the fixed device.

It should also be noted that while FIG. 3 illustrates one example of a configuration of an apparatus 50 for transferring content between services, numerous other configurations may also be used to implement embodiments of the present invention. As such, in some embodiments, although devices or elements are shown as being in communication with each other, hereinafter such devices or elements should be considered to be capable of being embodied within a same device or element and, thus, devices or elements shown in communication should be understood to alternatively be portions of the same device or element.

Referring now to FIG. 3, the apparatus 50 for transferring content between services may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

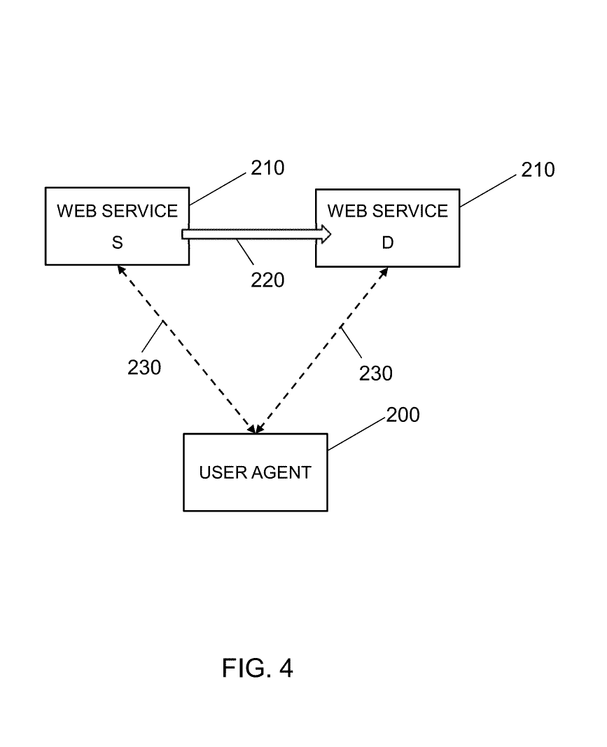

With reference now to FIGS. 4-6, a user may wish to transfer content from a source service, such as a web service associated with a social networking website, to a destination service, such as a web service associated with a photo sharing website. The user may access the web services 210 over a network, such as the Internet, via a user agent 200. As used herein, the term “user agent” refers to software that is acting on behalf of a user, such as software installed on the user device. In the example above, the user agent may be, for example, a web browser. For purposes of explanation, the source service 210 is denoted by the letter “S,” whereas the destination service is denoted by the letter “D.”

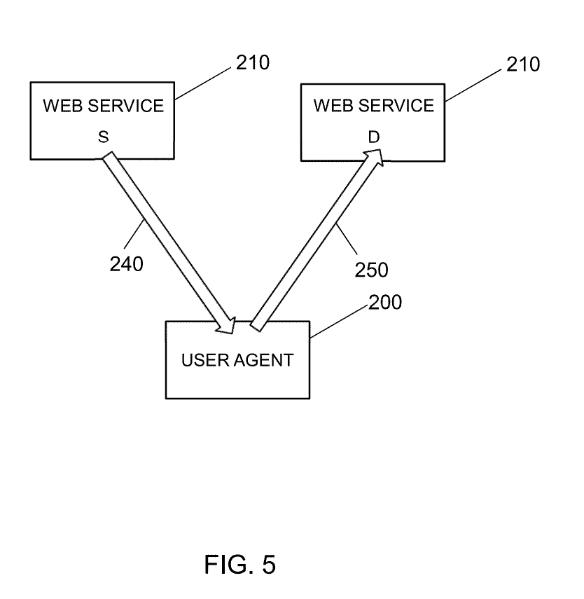

FIGS. 4 and 5 depict conventional ways that content may be transferred from a source service S to a destination service. In FIG. 4, the source service S may be configured to communicate with the destination service D, such that content (e.g., files) may be transferred from one service 210 to the other as part of a backend process. The transfer of content is depicted by the arrow 220. As a backend process, the transfer of content from source service S to destination service D is not directly accessibly by the user. Rather, it is a specialized function that is carried out on behalf of one or both web services 210, such as an operation that is instructed by the software of one or both of the services and executed by a process acting on behalf of the associated service (e.g., the processor of an associated web server). Thus, although the user may be able to access (e.g., view and/or manipulate) content on each service 210 (as depicted using the dashed line arrows 230) via the user agent 200 of the user device 100 shown in FIG. 1, the user in the conventional backend scenario of FIG. 4 would not have the ability to initiate or instruct a backend transfer of content from the source service S to the destination service D.

In FIG. 5, a conventional download/upload scenario for transferring content is depicted. In this scenario, a user is able to transfer content from the source service S to the destination service D by first manually downloading the content from the source service S to the local user device running the user agent 200 (the download operation being shown via the arrow 240), then manually uploading the content from the local user device to the destination service D (the uploading operation being shown via the arrow 250). As noted above with respect to FIG. 1, the conventional download/upload scenario, although controlled by the user via the user agent 200, can be tedious and time consuming and can require the user to possess technical knowledge (e.g., knowledge of certain computing terms and methods) that many users today do not have.

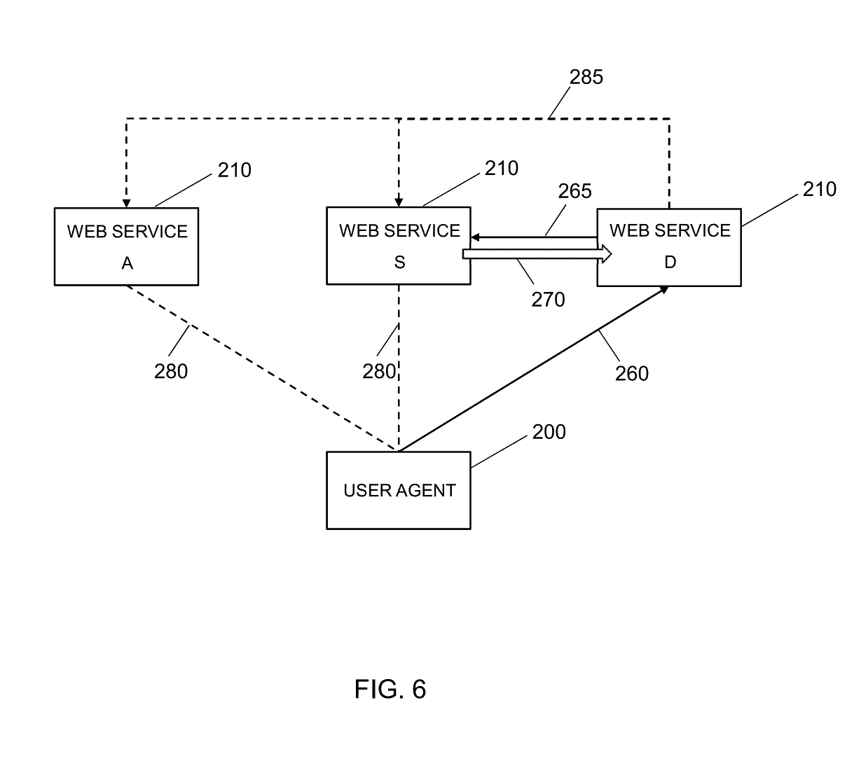

Accordingly, embodiments of the invention described herein provide mechanisms for allowing a user to initiate the transfer of content directly between two services 120, as illustrated in FIG. 6. In particular, as described in greater detail below, embodiments of the invention are configured to receive input from the user, such as via the user agent 200, selecting content for transferring from an available service 210 (e.g., web service A or S) to the destination service D. In response to such input, the selected content may be transferred directly from the source service S associated with the selected content to the destination service D. In this regard, the term “directly” refers to the transfer of content from one service to another without requiring the user to download content from the source service, then upload the content to the destination, even though the content may, in the process of being transferred from one service to another, be intercepted by or stored (permanently or temporarily) on intervening servers or devices.

As described above with reference to FIG. 3, the apparatus 50 may comprise at least one processor 70 and at least one memory 76 including computer program code. The at least one memory 76 and the computer program code may be configured to, with the processor 70, cause the apparatus 50 to at least provide for display of a webpage to a user, wherein the webpage is associated with a first service. The at least one memory 76 and the computer program code may be further configured to, with the processor 70, cause the apparatus 50 to receive input from the user, via the webpage, designating content to be transferred to the webpage, wherein the content is accessible via a second service. The content may be, for example, images, videos, sound files, documents, spreadsheets, or other types of files and content. The at least one memory 76 and the computer program code may be configured to, with the processor 70, cause the apparatus 50 to provide for transfer of the content designated from the second service to the first service, at the direction of the first service, in response to the receipt of the input. In this regard, the first service may be the destination service and the second service may be the source service.

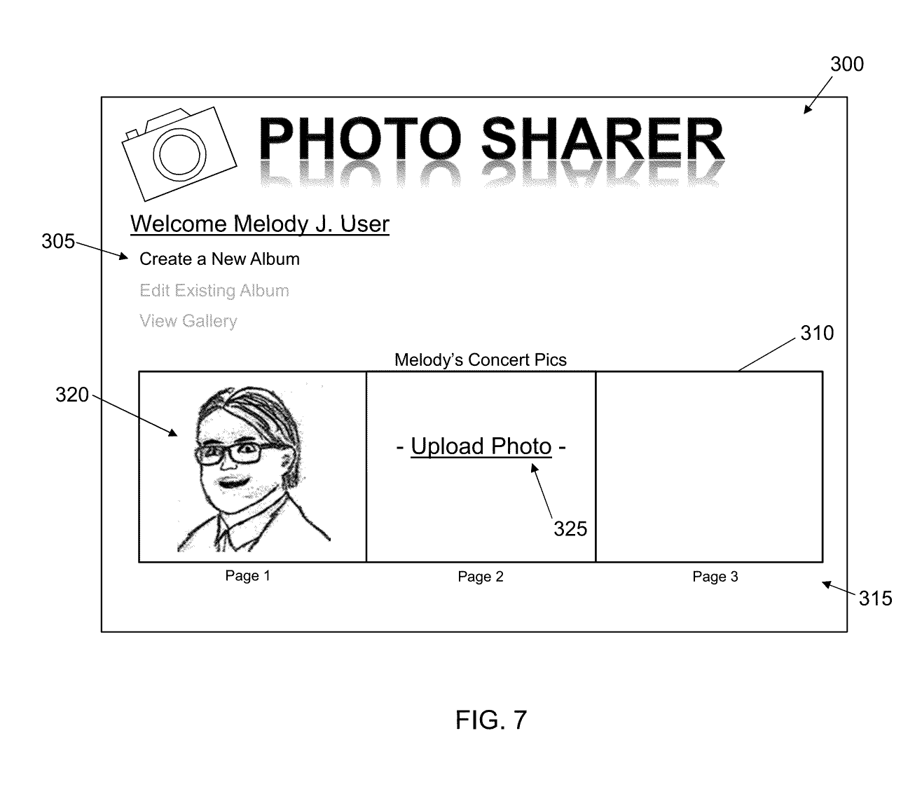

Turning to FIGS. 6 and 7, as an example, the user may be interacting with a first service 210, such as a photo sharing website (called “Photo Sharer” in the depicted example) via a user agent 200. The webpage 300 shown in FIG. 7 may be displayed to the user, and the user (Melody J. User) may be interacting with the webpage to create an album. For example, the user may have selected the option 305 on the left hand side of the webpage 300 to “Create a New Album,” and as a result, pages 310 of a new album 315 may be displayed for the user to fill with pictures.

In the depicted example, the user has already inserted a picture 320 in Page 1 of the album 315. The user may be presented with an option 325 to “Upload Photo” with respect to the next blank page 310 of the album 315 (page 2). In conventional systems, the user would, at this point, select the link 325 to “upload photo” presented on the screen and would then be prompted to specify a location on the local device (the user device) from which the content can be retrieved. Thus, in conventional systems, the user would be faced with a scenario as depicted in FIG. 5 in the event the content that the user wishes to upload to the photo sharing service is not found on the user's device, but rather resides on another service 210.

According to embodiments of the present invention, and with reference to FIGS. 6 and 7, the user can provide input (represented by the arrow 260 in FIG. 6) via the user agent 200 by interacting with the webpage 300 of FIG. 7, where the input designates content that is accessible via a second service such as a social networking site (e.g., service S in FIG. 6) to be transferred to the webpage associated with the first service (e.g., the photo sharing service D in FIG. 6). In response to the receipt of the input 260, the first service (e.g., service D in FIG. 6) may direct the transfer of content (such as a picture file) from the second service (e.g., service S in FIG. 6) to the first service (e.g., service D in FIG. 6). Communication between the first service (e.g., service D in FIG. 6) and the second service (e.g., service S in FIG. 6) directing the transfer of content is represented in FIG. 6 by the arrow 265; the transfer of content is represented by the arrow 270 in FIG. 6.

In some cases, the at least one memory and the computer program code may be configured to, with the processor, cause the apparatus to detect a user interface element in the webpage displayed to the user, wherein the user interface element is configured to receive the input from the user regarding the transfer of content to the first service. The user interface element may be a link (e.g., the link 325 show in FIG. 7), a button, a text input box, a radio button, or any other user interface element configured to receive input from the user regarding the transfer of content to the first service (e.g., the service associated with the webpage being displayed in the depicted example). For example, the user agent may detect that a user interface element has an input type equal to “file” (e.g., <input type=“file”>) and may, as a result, present the user with a choice to “sideload” that content from a service that the user is logged into, as described below.

In FIG. 7, for example, selection of the link 325 by the user indicates the user's desire to upload content to the photo sharing website. As such, embodiments of the invention may, upon detecting that the option to upload content is being offered to the user, also detect possible source services from which compatible content may be accessed.

Accordingly, the at least one memory and the computer program code may be configured to, with the processor, cause the apparatus to provide for display of an option to the user to transfer content from the second service to the first service in response to detection of the user interface element. The input 260 (shown in FIG. 6) from the user designating the content to be transferred may thus be received via the option presented to the user.

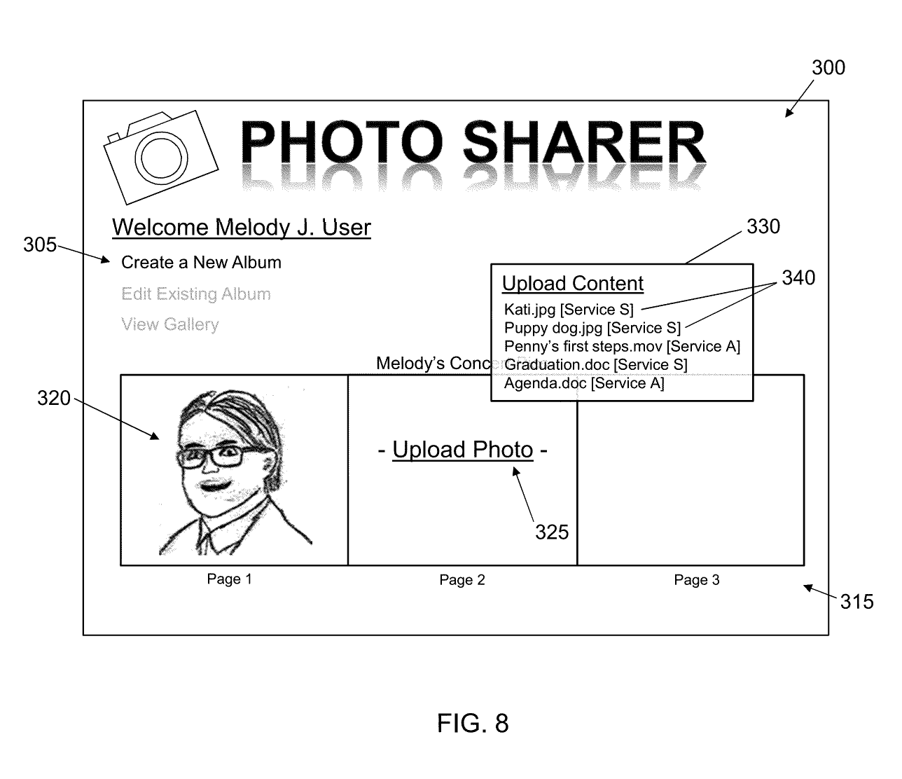

With reference to FIG. 8, for example, upon the user's selection of the “Upload Photo” link 325, a menu 330 may be presented to the user (e.g., overlaid on the website content) that provides a list of content files 340 that may be uploaded to the website. The content files 340 may be from one or more available source services.

For example, with reference to FIG. 6, the at least one memory and the computer program code may be configured to, with the processor, cause the apparatus to detect one or more potential source services 210 that are accessible to the destination service. Such services from which the user may be able to select content may, for example, include services with which the user has an established connection 280 (indicated in FIG. 6 by dashed lines). An established connection 280 may exist if the user is logged into an account on the respective service, even if the user is not currently viewing or interacting with that particular service. For example, in FIG. 6, the user may be logged into a social networking account (e.g., web service S) and a retail website account (e.g., web service A). The apparatus in this example may be configured to detect the connections 280 with these two services S, A, such as via communication with each of the services (depicted via dashed line arrows 285).

In some embodiments, the at least one memory and the computer program code may be configured to, with the processor, cause the apparatus to determine an acceptable type of content for transfer to the first service. The user agent, for example, may detect the mimetype accepted by the file input. The apparatus may further be caused (via the processor) to identify at least one second service that is capable of providing content according to the type of content determined to be acceptable. For example, the processor may be configured to receive data from the first service (the photo sharing website in the depicted examples) indicating the file extensions that are compatible with the first service (e.g., file types that can be uploaded to and/or displayed on) the webpage 300. In the example illustrated in FIG. 8, the apparatus has determined that at least files having the extension .jpg, .mov, and .doc are acceptable file types. The apparatus has further identified that both detected services (service A and service S in FIG. 6) are capable of providing content according to the type of content determined to be acceptable. Thus, in the depicted example, three content files from service S are considered to be compatible with the first service, and two content files from service A are considered to be compatible with the first service. These five files 340 are displayed to the user in the menu 330.

Upon reviewing the list of content files 340 shown in FIG. 8, the user may select one of the files for transfer to the first service. For example, the user may click on “Kati.jpg” (e.g., by double-clicking) to provide input that the user would like the selected content file transferred from its source location (in this case, service S in FIG. 6) to the destination service D. Thus, in this example, the input designating the content to be transferred to the webpage (shown in FIG. 6 via the arrow 260) is received via selection of the menu of options 330 shown in FIG. 8.

Accordingly, in some embodiments, the at least one memory and the computer program code may be configured to, with the processor, cause the apparatus to receive input designating the content to be transferred a via a user interface component of the user agent (e.g., the web browser) used by the user to access the webpage. An example of a user interface component for receiving the user's input designating the content to be transferred may be the menu 330 that is displayed to the user in the example depicted in FIG. 8.

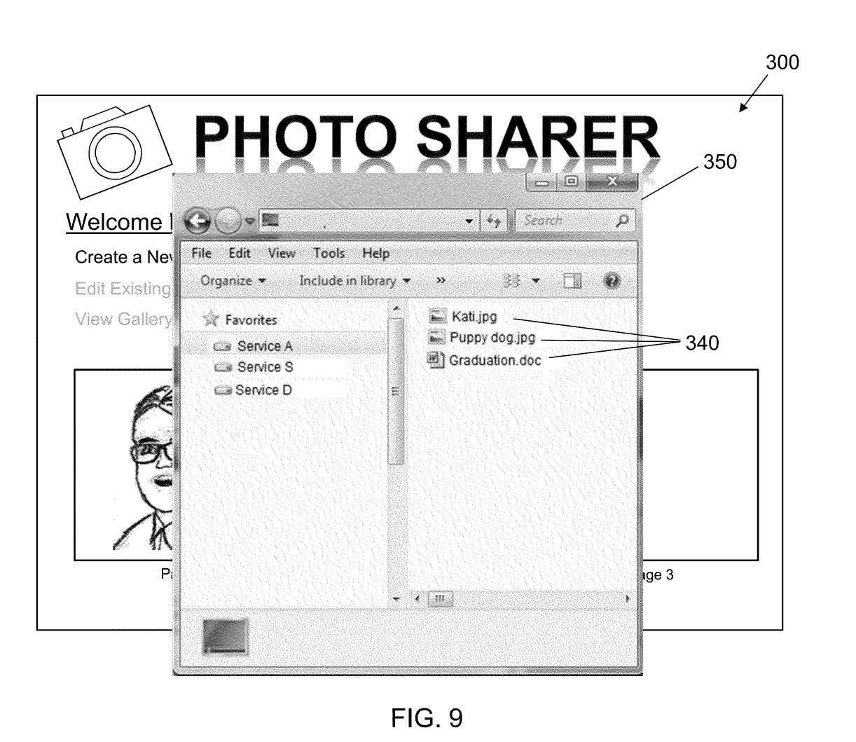

In other embodiments, however, the at least one memory and the computer program code may be configured to, with the processor, cause the apparatus to receive input designating the content via a file dialog component of an operating system used by the user to access the webpage. With reference to FIG. 9, for example, the operating system of the local user device (e.g., the user device running the user agent and via which the user is accessing the webpage 300 shown in FIG. 7) may generate a file dialog component 350 that allows users to browse the folders of their local device or any remote location on the network (including, for example, folders and files residing on services A, S, and D to which the user is connected in the example above). Using the file dialog component 350, the user can browse and select one or more content files 340 to upload to the first service (service D in the depicted example).

Regardless of how the input designating the particular content to be transferred is received, once the content has been designated by the user, the content may be transferred from the source service to the destination service in various ways. The at least one memory and the computer program code may be configured to, with the processor, cause the apparatus to provide for transfer of the content designated from the second service to the first service by downloading the content from the second service (e.g., to a local memory) and then uploading the content to the first service (e.g., from the local memory). Although this method of transferring the content may involve downloading and uploading operations, the downloading and uploading operations are executed at the direction of the first service, rather than manually by the user. Thus, to the user, the downloading and uploading of the content that may occur may not be readily apparent and, in any case, would not require any further action by the user to accomplish.

In other embodiments, however, the at least one memory and the computer program code may be configured to, with the processor, cause the apparatus to provide for transfer of the content designated from the second service to the first service by identifying a Uniform Resource Locator (URL) associated with the content designated and passing the URL to the first service. For example, rather than requiring a user to manually determine the URL associated with particular content that the user wishes to transfer to the destination service and providing that URL to the destination service (e.g., by typing in the URL or copy-and-pasting the URL into the destination service), embodiments of the invention cause the apparatus to identify the URL associated with the content designated by the user and pass the URL directly to the destination service, such that the user does not need to interact with the source service for the content at all. This scenario may arise, for example, in a case in which the user recently browsed content (e.g., a photo) on the Web and desires to transfer that content for use with another service (without having to copy and paste the URL explicitly).

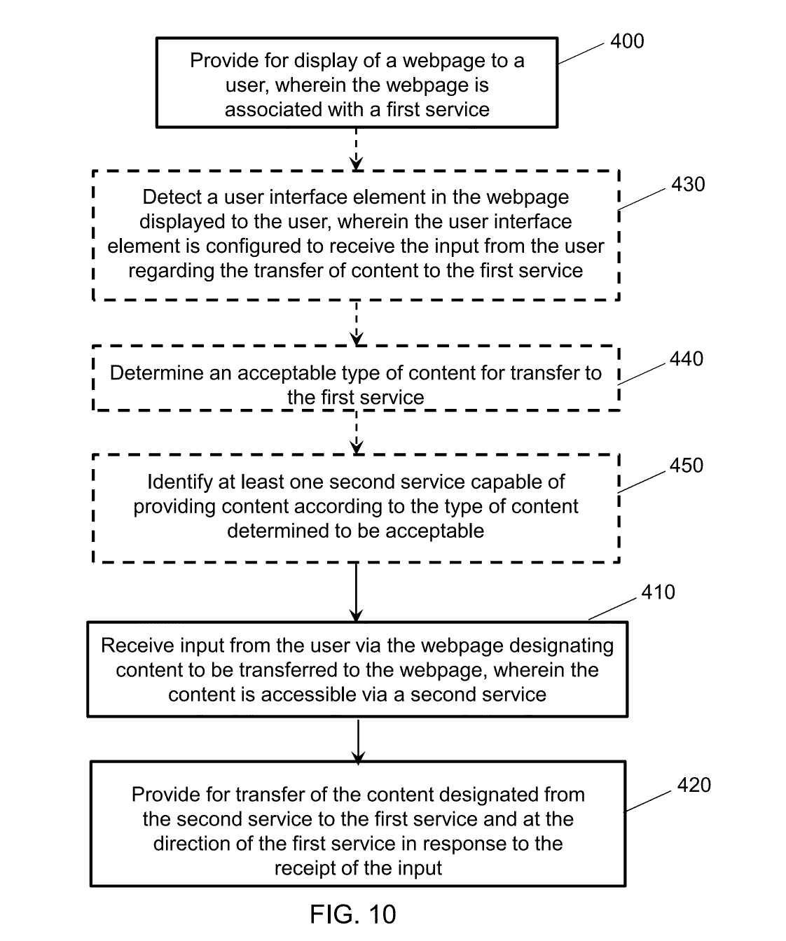

FIG. 10 illustrates a flowchart of systems, methods, and computer program products according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an example embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one example embodiment of a method for transferring content between services is shown in FIG. 10. FIG. 10 depicts an example embodiment of the method that includes providing for display of a webpage to a user, where the webpage is associated with a first service, at block 400. The webpage may be, for example, a webpage of a website for a photo sharing service, as provided in the description above and the associated figures. Input from the user may be received via the webpage, where the input designates content to be transferred to the webpage, and wherein the content is accessible via a second service, such as a social networking service as described above, at block 410. The transfer of the content designated may be provided for at block 420, where the transfer is made from the second service to the first service and at the direction of the first service in response to the receipt of the input. Thus, the second service may be a source service, and the first service may be a destination service.

In some embodiments, a user interface element may be detected in the webpage displayed to the user at block 430. The user interface element may be configured to receive the input from the user regarding the transfer of content to the first service. For example, display of an option to the user may be provided for to transfer content from the second service to the first service in response to detection of the user interface element. The input from the user designating the content to be transferred may be received via the option presented to the user.

Furthermore, in some cases, an acceptable type of content for transfer to the first service may be determined at block 440. Additionally or alternatively, at least one second service capable of providing content according to the type of content determined to be acceptable may be identified at block 450.

In some embodiments, certain ones of the operations above may be modified or further amplified as described below. Furthermore, in some embodiments, additional optional operations may be included, some examples of which are shown in dashed lines in FIG. 10. Modifications, additions, or amplifications to the operations above may be performed in any order and in any combination.

In an example embodiment, an apparatus for performing the methods of FIG. 10 above may comprise a processor (e.g., the processor 70 of FIG. 3) configured to perform some or each of the operations (400-450) described above. The processor may, for example, be configured to perform the operations (400-450) by performing hardware implemented logical functions, executing stored instructions, or executing algorithms for performing each of the operations. Alternatively, the apparatus may comprise means for performing each of the operations described above. In this regard, according to an example embodiment, examples of means for performing operation 400 may comprise, for example, the communication interface 74, the user interface transceiver 72, the processor 70, the memory device 76, and/or a device or circuit for executing instructions or executing an algorithm for processing information as described above. Examples of means for performing operation 430 may comprise, for example, the user interface transceiver 72, the processor 70, the memory device 76, and/or a device or circuit for executing instructions or executing an algorithm for processing information as described above. Examples of means for performing operation 440 may comprise, for example, the processor 70, the memory device 76, and/or a device or circuit for executing instructions or executing an algorithm for processing information as described above. Examples of means for performing operations 420 and 450 may comprise, for example, the communication interface 74, the processor 70, the memory device 76, and/or a device or circuit for executing instructions or executing an algorithm for processing information as described above. Examples of means for performing operation 410 may comprise, for example, the user interface transceiver 72, the processor 70, the memory device 76, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although the depicted embodiments and associated examples describe the transfer of content (a photo) from a social networking service to a photo sharing service, it is understood that embodiments of the invention may provide for the transfer of various types of content between different types of services. Accordingly, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
provide for display of a webpage to a user, wherein the webpage is associated with a first service;
receive input from the user, via the webpage, designating content to be transferred to the webpage, wherein the content is accessible via a second service;
provide for transfer of the content designated from the second service to the first service and at the direction of the first service in response to the receipt of the input.

2. The apparatus of claim 1, wherein the at least one memory and the computer program code are further configured to, with the processor, cause the apparatus to detect a user interface element in the webpage displayed to the user, wherein the user interface element is configured to receive the input from the user regarding the transfer of content to the first service.

3. The apparatus of claim 2, wherein the at least one memory and the computer program code are further configured to, with the processor, cause the apparatus to provide for display of an option to the user to transfer content from the second service to the first service in response to detection of the user interface element, wherein the input from the user designating the content to be transferred is received via the option presented to the user.

4. The apparatus of claim 1, wherein the at least one memory and the computer program code are configured to, with the processor, cause the apparatus to receive input designating the content via a user interface component of a user agent used by the user to access the webpage.

5. The apparatus of claim 1, wherein the at least one memory and the computer program code are configured to, with the processor, cause the apparatus to receive input designating the content via a file dialog component of an operating system used by the user to access the webpage.

6. The apparatus of claim 1, wherein the at least one memory and the computer program code are further configured to, with the processor, cause the apparatus to determine an acceptable type of content for transfer to the first service.

7. The apparatus of claim 6, wherein the at least one memory and the computer program code are further configured to, with the processor, cause the apparatus to identify at least one second service capable of providing content according to the type of content determined to be acceptable.

8. A method comprising:
providing for display of a webpage to a user, wherein the webpage is associated with a first service;
receiving input from the user, via the webpage, designating content to be transferred to the webpage, wherein the content is accessible via a second service;
providing, via a processor, for transfer of the content designated from the second service to the first service and at the direction of the first service in response to the receipt of the input.

9. The method of claim 8 further comprising detecting a user interface element in the webpage displayed to the user, wherein the user interface element is configured to receive the input from the user regarding the transfer of content to the first service.

10. The method of claim 8, wherein receiving input from the user via the webpage comprises receiving input designating the content via a user interface component of a user agent used by the user to access the webpage.

11. The method of claim 8, wherein receiving input from the user via the webpage comprises receiving input designating the content via a file dialog component of an operating system used by the user to access the webpage.

12. The method of claim 8 further comprising determining an acceptable type of content for transfer to the first service.

13. The method of claim 8 further comprising identifying at least one second service capable of providing content according to the type of content determined to be acceptable.

14. A computer program product comprising at least one non-transitory computer-readable storage medium having computer-executable program code portions stored therein, the computer-executable program code portions comprising program code instructions for:
providing for display of a webpage to a user, wherein the webpage is associated with a first service;
receiving input from the user, via the webpage, designating content to be transferred to the webpage, wherein the content is accessible via a second service;
providing for transfer of the content designated from the second service to the first service and at the direction of the first service in response to the receipt of the input.

15. The computer program product of claim 14 further comprising program code instructions for detecting a user interface element in the webpage displayed to the user, wherein the user interface element is configured to receive the input from the user regarding the transfer of content to the first service.

16. The computer program product of claim 15 further comprising program code instructions for providing for display of an option to the user to transfer content from the second service to the first service in response to detection of the user interface element, wherein the input from the user designating the content to be transferred is received via the option presented to the user.

17. The computer program product of claim 14, wherein the program code instructions for receiving input from the user via the webpage further comprise program code instructions for receiving input designating the content via a user interface component of a user agent used by the user to access the webpage.

18. The computer program product of claim 14, wherein the program code instructions for receiving input from the user via the webpage further comprise program code instructions for receiving input designating the content via a file dialog component of an operating system used by the user to access the webpage.

19. The computer program product of claim 14 further comprising program code instructions for determining an acceptable type of content for transfer to the first service.

20. The computer program product of claim 14 further comprising program code instructions for identifying at least one second service capable of providing content according to the type of content determined to be acceptable.
